(19) United States
(12) Patent Application Publication
(10) Pub. No.: US 2003/0055715 A1
(43) Pub. Date: Mar. 20, 2003

(54) Event driven material forecasting

(76) Inventor: Jeffrey Spence, Foothill Ranch, CA (US)

Correspondence Address: ARTER & HADDEN, LLP, 1100 HUNTINGTON BUILDING, 925 EUCLID AVENUE, CLEVELAND, OH, 44115-1475, US

(21) Appl. No.: 10/227,932

(22) Filed: Aug. 26, 2002

Related U.S. Application Data
(60) Provisional application No. 60/314,707, filed on Aug. 24, 2001.

(51) Int. Cl. G06F 17/60

(52) U.S. Cl. 705/10; 705/22; 705/28

(57) ABSTRACT

An event driven material forecasting system that projects a recommended bill of materials. Data is input into the system identifying scheduled demand. The system then identifies situations where scheduled orders failed to meet actual demand to forecast specific requirements to meet the scheduled demand. The system further tracks milestones for each situation where the scheduled order failed to meet demand and calculates a percentage for how many times the scheduled order failed to meet the demand for the milestone. The system then calculates a new projected bill of materials which is then compared with an inventory level and an inventory order stream to determine if sufficient materials will be available.

### CROSS-REFERENCE TO RELATED APPLICATIONS

This application claims the benefit of U.S. Provisional Application No. 60/134,707 filed Aug. 24, 2001.

### BACKGROUND OF THE INVENTION

This invention is related to a system of forecasting and provisioning material needs based upon numerous input criteria.

The airline industry is intensely competitive, and thus any change in business operations that offers a cost savings may provide the “edge” to remain in business longer hat a competitor. A major cost area is the repair and maintenance of the aircraft. The aircraft, in theory, should only be taken out of service for a minimal amount of time necessary to perform routine maintenance and in some cases, more significant repairs. However, this can become a costly endeavor where a flight schedule puts the aircraft in one city and the parts scheduled for the repair and maintenance of that aircraft are in another. In order to anticipate such operational errors the airline or maintenance contractor would need to maintain a substantial inventory of parts to ensure that no matter where the aircraft may be, there are parts available for the maintenance and repair procedure to minimize the aircraft downtime. Not only are wages of maintenance personnel lost, but in more extreme scenarios, the aircraft may be grounded at that location awaiting the arrival of the parts and, and in more serious situations, experienced personnel.

Furthermore, many parts are expensive, and maintaining an inventory of such parts adds to “the bottom-line.” A more efficient system would provide that such an expensive part would arrive directly from the supplier or manufacturer only when needed at a particular maintenance and repair facility. This “just-in-time” feature offers enormous savings in inventory costs and resources as neither is inventory of such equipment required nor are the personnel to oversee and maintain such inventory.

Therefore, the exists for a system that efficiently forecasts and schedules the availability of parts and personnel in preparation for the maintenance and repair of aircraft on the basis of input parameters normally utilized in day-to-day airline operations.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of instrumentalities and combinations particularly pointed out in the appended claims.

### BRIEF SUMMARY OF THE INVENTION

In view of the aforementioned needs, the invention contemplates a computerized airline maintenance system that receives data input from various sources and based on the data projects the materials needed for the performance of maintenance tasks. The data comprises static data, such as scheduled preventative maintenance as well as dynamic data, such as mileage of airplanes, updated maintenance schedules, and on-hand inventories of various facilities. Because aircraft are constantly moving from facility to facility, the present invention determines where the aircraft will be located at the time service is required and whether there are sufficient materials at the service location.

One aspect of the present invention is directed to an event driven material forecasting method. The method comprises defining check requirement, wherein the check requirement including, but is not limited to a frequency and a pre-determined part. The method further comprises storing an observed requirement wherein the observed requirement comprises a replaced part. The method further comprises projecting an inventory demand based on the pre-determined part and the replaced part, and determining an order quantity after matching the inventory demand to an inventory level and matching the demand to an inventory order stream. The method may further comprise defining milestones or a frequency when the replacement part is needed, and a percentage of occurrences that the replacement part is needed can be calculated for the defined milestone or frequency.. The method may be utilized for an inventory system wherein inventory items are located at a plurality of locations, the projected demand being calculated separately for each location.

Another aspect of the present invention is directed to a computer implemented event driven material forecasting method for maintaining an aircraft. The method comprises defining check requirement for an aircraft, wherein the check requirement including, but is not limited to a frequency and a pre-determined part. The method further comprises storing an observed requirement for the aircraft wherein the observed requirement comprises a replaced part. The method further comprises projecting an inventory demand based on the predetermined part and the replaced part, and determining an order quantity after matching the inventory demand to an inventory level and matching the demand to an inventory order stream. The method may further comprise defining milestones or a frequency when the replacement part is needed, and a percentage of occurrences that the replacement part is needed can be calculated for the defined milestone or frequency.. The method may be utilized for an inventory system wherein inventory items are located at a plurality of locations, the projected demand being calculated separately for each location. The method may further comprise determining a location from a plurality of locations where an aircraft may be located. The method may be implemented in hardware, software, or a combination thereof.

Yet another aspect of the present invention is computer implemented event driven material forecasting method for maintaining aircraft, the steps comprising defining check requirement for an aircraft, wherein the check requirement comprises a frequency and a predetermined part; storing an observed requirement for the aircraft, wherein the observed requirement comprises identifying a replaced part; projecting an inventory demand based on the pre-determined part and the replaced part; and determining an order quantity after matching the inventory demand to an inventory level and matching the demand to an inventory order stream. The computer implemented even driven material forecasting method for maintaining aircraft may be implemented in hardware, software, or a combination thereof.

In still yet another aspect of the present invention there is contemplated a computer readable medium of instructions comprising means for defining check requirements for an aircraft, wherein the check requirements comprises a frequency and a pre-determined part; means for storing an observed requirement for the aircraft, wherein the observed requirement comprises identifying a replaced part; means for projecting an inventory demand based on the pre-determined part and the replaced part; and means for determining an order quantity after matching the inventory demand to an inventory level and matching the demand to an inventory order stream. It is contemplated that the computer readable medium of instructions may be implemented in hardware, software, or a combination thereof.

In yet still another aspect of the present invention there is contemplated a system for providing event driven material forecasting comprising a computing device having a memory, a database in the memory, and an application program for execution on the computing device. The database including part data, the part data comprising a scheduled demand data, unscheduled demand data, an inventory level, and an inventory order stream. The application program accessing the database for projecting an inventory demand based on the scheduled demand data and the unscheduled demand data and determining a an order quantity, after matching the inventory demand to an inventory level and matching the demand to an inventory order stream.

Among those benefits and improvements that have been disclosed, other objects and /advantages of this invention will become apparent from the following description taken in conjunction with the accompanying drawings. The drawings constitute a part of this specification and include exemplary embodiments of the present invention and illustrate various objects and features thereof.

### BRIEF DESCRIPTION OF THE SEVERAL VIEWS OF THE DRAWING

The drawings illustrate the best mode presently contemplated of carrying out the invention.

This the drawings:

FIG. 1 is a block diagram illustrating some of the sources of data contemplated by the present invention;

FIG. 2 illustrates an aircraft which is pictorially divided into zones for the purposes of maintenance and repair;

FIG. 3 illustrates a simple maintenance plan;

FIG. 4 illustrates a system process flow diagram for the disclosed event-driven forecast system;

FIG. 5 illustrates a flow chart of the process for implementing the disclosed architecture;

FIG. 6 illustrates a block diagram connecting multiple airline systems with the system of the present invention;

FIG. 7 is a block diagram showing data relationships as contemplated in a preferred embodiment of the present invention;

FIG. 8 is a block diagram illustrating the process flow and relationship of the maintenance process to the procurement process typical of the prior art; and

FIG. 9 is a block diagram illustrating the process flow and relationship of maintenance process to the procurement process as contemplated by a preferred embodiment of the present invention.

### DETAILED DESCRIPTION OF INVENTION

Throughout this description, the preferred embodiment and examples shown should be considered as exemplars, rather than limitations, of the present invention.

Event driven Material Forecasting (EDMF) is a system with an integrated analysis capability for use in sustaining fleets. It facilitates the delivery of required parts to the point of usage. For example, in the airlines industry, airline companies and related repair facilities can operate more efficiently and effectively by having the capability of providing parts and the necessary personnel available when the aircraft is scheduled for maintenance and repair. This efficiency translates into lower operating costs.

The EDMF of the present invention creates a recommended Bill-of-Materials (BOM) which may include consumables, pieces parts (or Line Replacement Units—LRU's) for a given Task, scheduled at a given time. Material requirements can then be identified at the tail number (aircraft identification number) using the process identified herein. The basic reporting requirement is to identify situations, i.e. when and where the scheduled orders failed to meet actual demand and to forecast specific requirements to meet the scheduled demand such that part overages or shortages are reduced or eliminated.

The EDMF system includes input parameters, output parameters, and the interstitial process for generating the output from the input. The input parameters include, for example, maintenance schedules for a particular aircraft, the number of hours in a maintenance cycle (hours/cycle), the particular event being performed, the pre-pull parts, and the inventory level for the parts. The output parameters include for example an electronically formatted bill-of-materials, the pre-pull parts list, the recommended parts for unscheduled demands which are with a high degree of probability likely to require replacement when performing maintenance in the area of the particular maintenance event.

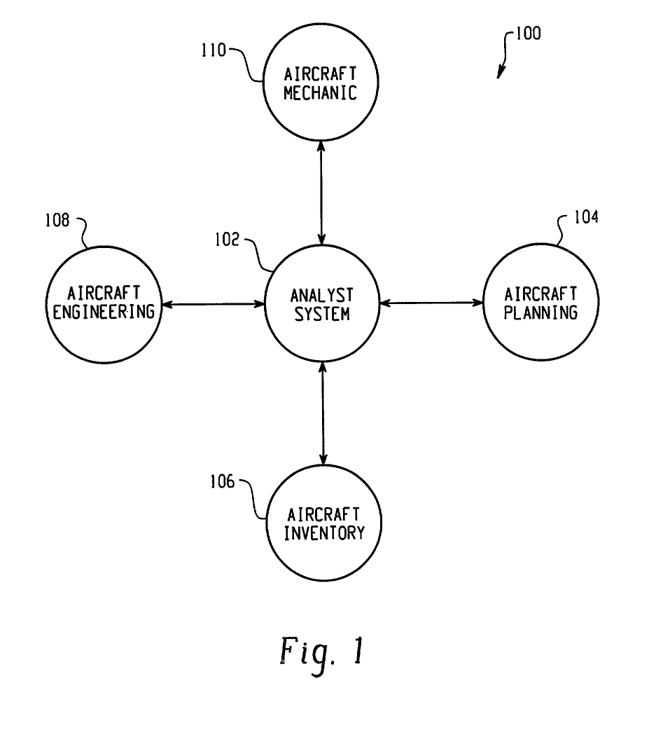

Referring to FIG. 1, there is shown a block diagram 100 illustrating some of the data inputs into the analyst system 102. Information and raw data is collected from any number of entities entered into the disclosed system for processing. In this particular embodiment, the system processes data received from aircrat planning 104, aircraft inventory 106, aircraft engineering 108, and aircraft mechanics 110. Of course other sources information can be entered into the analyst system 102 for processing in order to obtain the desired output. the system is operable to process information entered by the aircraft mechanic 110, such that front-line information is factored into the output. For example, over time an aircraft mechanic 110 may replace a particular part not scheduled for replacement. This unscheduled replacement may occur at a particular milestone, eg 10,000 hours or at a frequency, such a every 5,000 miles. Whenever the unscheduled replacement is made, the aircraft mechanic 110 enters the required part data into the analyst system 102.

The Airline Planning Department 104 typically inputs data related to scheduling the availability of the aircraft and the location of the aircraft where the maintenance is to occur. For example, an aircraft is scheduled to arrive in Atlanta on a given date when an inspection for FAA compliance must occur. The Planning Department 104 must also provide the duration in time for a particular task, the frequency of occurrence, and the necessary resources such as parts, number of mechanics and estimated hours.

The Aircraft Engineering Deparmtent 108 typically develops procedures for repairing or replacing parts, and/or the procedures for inserting new updated parts or designs. If new parts are required, the Aircraft Engineering Department 108 determines the design of the materials, where to obtain the materials or how to fabricate them.

Input from the Aircraft Inventory 106 feeds the system with all available inventory. For aircraft maintenance, the location of the particular part would also be stored. The analyst system 102 uses the aircraft inventory 106 data to determine if and when parts need to be ordered.

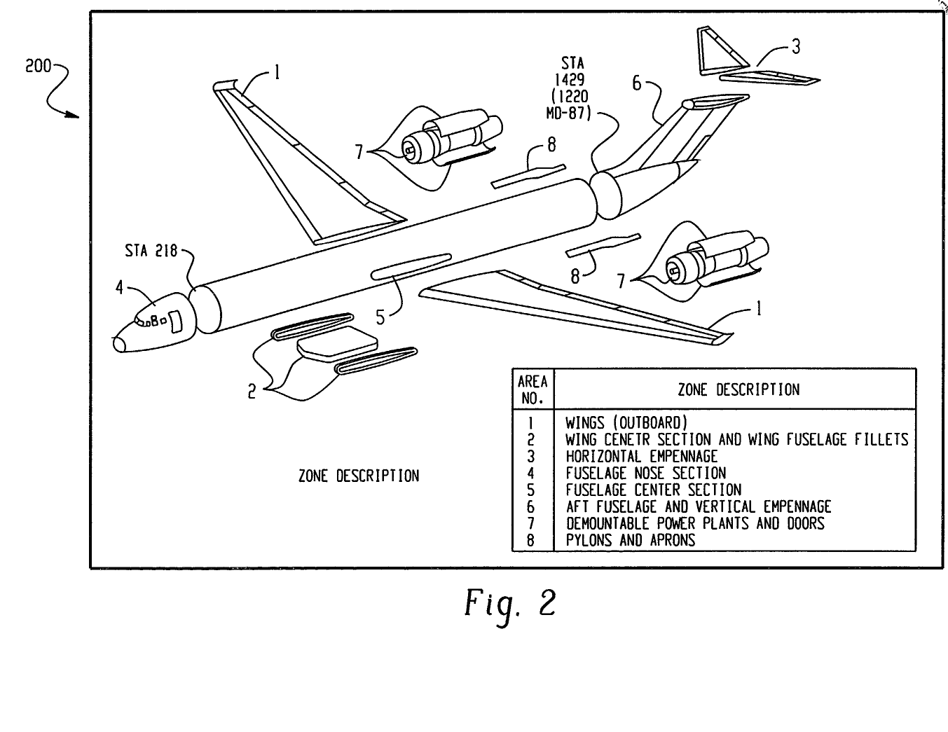

Referring now to FIG. 2 there is illustrated an aircraft 200 which is pictorially divided into zones as is typical for the purposes of maintenance and repair. The aircraft 200 is initially divided into zones during engineering and is used for construction purposes. The present invention takes advantage of the existing methodology and extends it for use in maintenance and repair scheduling. For example, if maintenance needs to be performed on the wing outboard section, there is a corresponding section of a maintenance plan that the technician views for Zone 1, and accesses the information As shown in FIG. 2 the aircraft is divided into eight zones. Zone 1 is wings (outerboard). Zone 2 is wings center section and wings/fuselage fillets. Zone 3 is the horizontal empennage. Zone 4 is the fuselage nose section. Zone 5 is the fuselage center section. Zone 7 is the demountable power plants and doors. Zone 8 is the pylons and aprons.

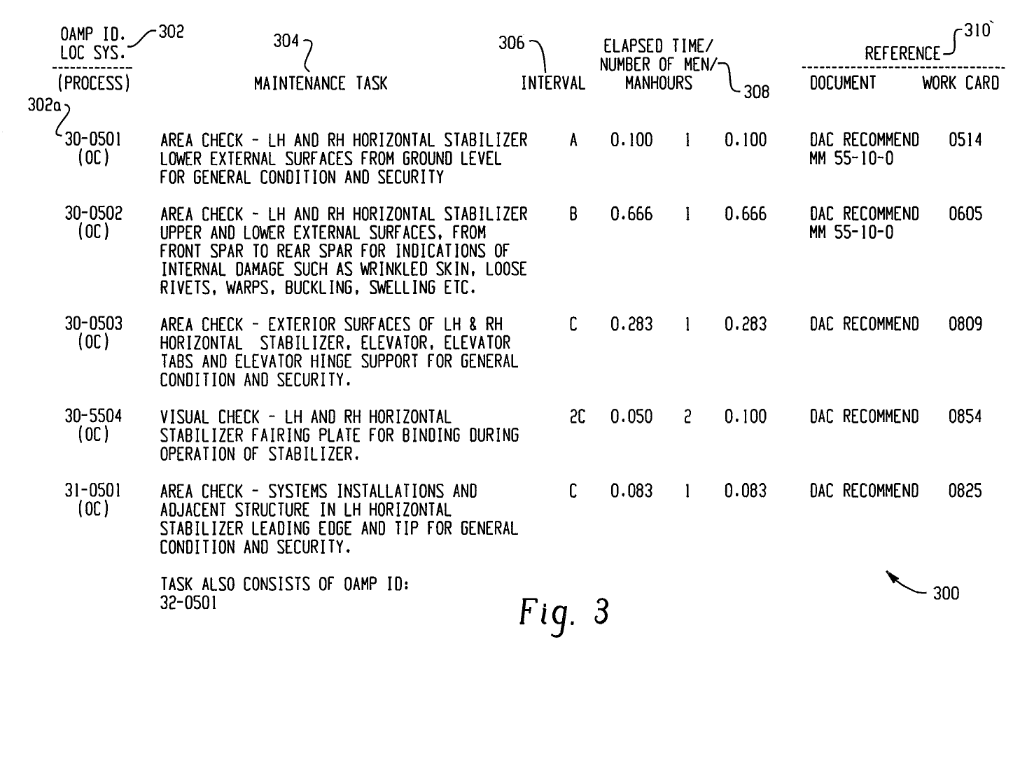

Referring now to FIG. 3 there is illustrated a sample maintenance plan. 300. Under the first column 302, the OAMP ID (On Aircraft Maintenance Planning document ID number) is used. In the first line item number 302a is the number 30-0501. The digits “30” denoting the zone (See FIG. 2) and sub-zone (not shown) of the aircraft 200. Although not illustrated here, the sub-zone digit “0” is used to further define the location on the aircraft 200. The digits “0501 ” indicate that the procedure is an Area Check and provides the procedure that the technician is to perform. The “OC” underneath the first line item number 302a means “On Condition” which indicates that although the inspection is visual, any conditions requiring repair must be addressed if spotted. The Maintenance Task column 304 defines the task that must be perfomed. The interval column 306 uses an alphanumeric code to indicate the time cycle for the check. For example, an A check must be performed every ten days, a B check every month, etc. The Elapsed Time/Number of Man Hours column 308 defines the estimated time to complete the task, the estimated number of personnel, and the estimated number of man hours. The reference column 310 provides the name and type of reference document, work card number that must be completed after the inspectio or maintenance task. Additionally, information is provided to identify the aircraft, e.g. DAC could be an abbreviation for Douglas Aerospace Corporation whose recommendations are being followed for the particular procedure. The first line item 302a, (30-0501), has an associated work card number “0514”. All work done on an airplane has to have a work card. The work card describes the task in detail.

Maintenance Plans can be developed in a number of ways. For example, a small airline company who contracts out to a maintenance and repair contractor for such work can go to the aircraft manufacturer and buy the whole Maintenance Plan from the manufacturer. The small carrier then presents that plan to the local FAA inspector, i.e. a PMI (Primary Maintenance Inspector) for the airline itself, for approval. Upon approval by the PMI, the small carrier must then perform maintenance and repair according to that Maintenance Plan. In contrast, a major airline company that has its own engineering group may use the aircraft manufacturer Maintenance Plan as a guideline from which to further modify for airline's benefit, e.g., to consolidate some of the word cards, or even further delineate some work cards, insofar as the modified plan is approved by a PMI.

The work cards are associated back to the inspection numbers in order to prove to the FAA that the minimum inspection requirements according to the approved Maintenance Plan have been met. The disclosed analysis system uses that Maintenance Plan number from the manufacturer which links the work cards to the corresponding airline Maintenance Plans.

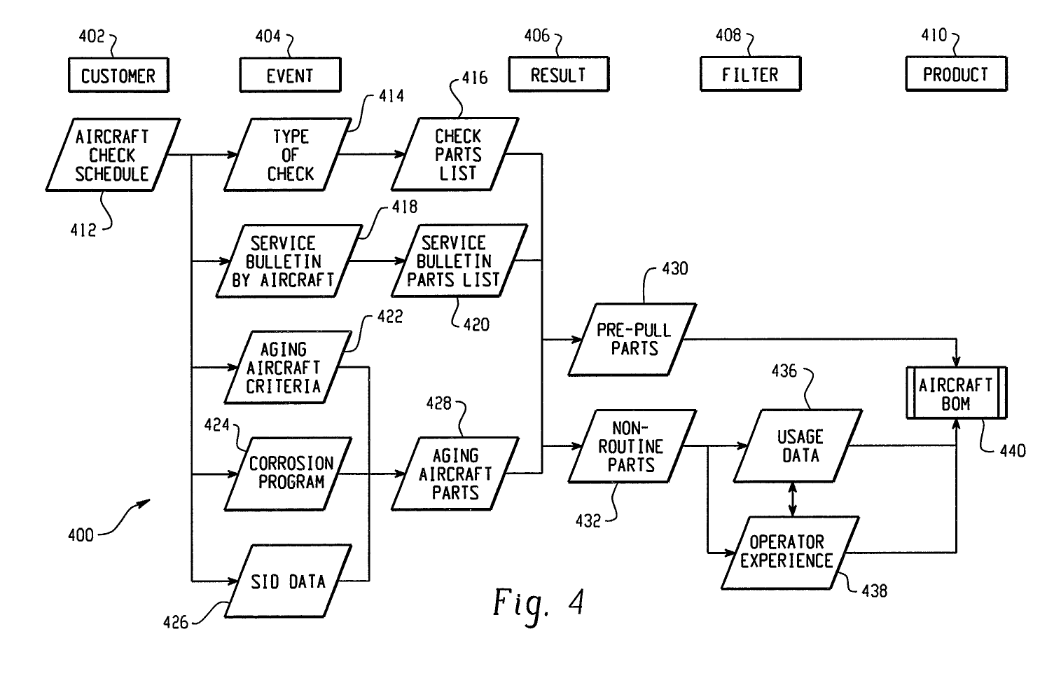

Referring now to FIG. 4, there is illustrated a system process flow diagram 400 for the present invention. The process comprises five sub-sections, Customer 402, Event 404, Result 406, Filter 408 and Product 410. In this particular embodiment, the Customer input 402 is an aircraft check schedule 412. the events listed under the event subsection 404 and which drive the forecast system, include the type of check, 414 an aircraft service bulletin 418, aging aircraft criteria 422, corrosion program 424, and SID data 426. The inter-stage output of the Event subsection 404 is as follows. Based upon the particular type of plane associated with the tail identification number input as part of the aircraft check schedule, A check parts list 416 is generated as an output of the type-of-check block 414. Based upon the same information, a service bulletin parts list 420 is output from the aircraft service bulletin block 418. A list of aging aircraft parts 428 is generated as the output of the combined blocks of aging aircraft criteria 422, corrosion program 424, and SID data 426. In response to the check parts list block 416, service bulletin parts list block 420, and aging parts list block 428 of the Result subsection 406, a pre-pull parts list 430 and non-routine parts list 422 are generated and passed to the Filter subsection 408. Filtering occurs on the non-routine parts list block to assign the operator. the filter sub-section 408 comprises two blocks, usage data 436 and operator experience 438. The usage data 436 and operator experience 438 refer to data collected regarding at what point in time, either a milestone or a frequency of occurrence wherein a non-routine part was needed, and how often the part was needed. For example, if it is observed that a certain part is replaced 40% of the time when a plane is inspected at 20,000 hours, the usage data 436 and operator experience 438 blocks use these observations when calculating the amount of non-routine parts 422 needed. Finally, the aircraft bill-of-materials 440 is generated after adding the non-routine parts 422 as filtered by the usage data 436 and operator experience 438 to the pre-pull parts 430.

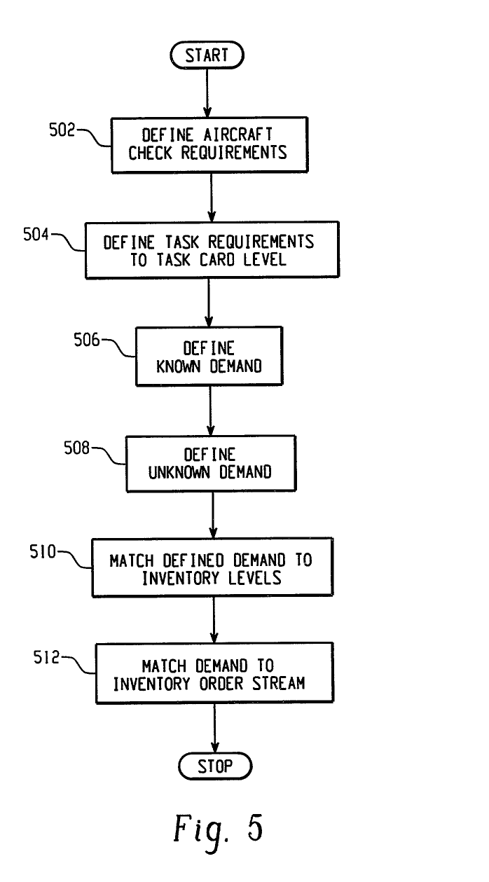

Referring now to FIG. 5, there is illustrated a flow chart of the process for implementing the disclosed architecture. Flow begins at a Start block and moves to a function block 502 where aircraft check requirements are defined. Check requirements includes specific maintenance requirements which are documented and identified during aircraft certification by regulating agencies and manufacturers. Tasks and required frequencies are specified in the manufacturer's recommended maintenance programs. These tasks are required to adequately maintain each aircraft. Most airlines use the manufacturer's Maintenance-Planning Document (MPD), and will customize/modify it to meet their requirements. The manufacturing MPD is the bridge between the regulatory agency requirements and the airline's proof-of-compliance for the requirements. Using the manufacturer's MPD as a common reference point allows the sharing of data between airlines.

Flow continues to a function block 504 where task requirements for each maintenance visit are defined to the task card level. A task spawns one or more maintenance actions for an airplane. A maintenance action can be as basic as a single task, e.g., a pre-flight check, or a more detailed major check which consists of many tasks. The larger and more detailed the check, the more detailed the tasks that are required. The required tasks can then be broken down into work cards. Work cards define the work to be accomplished and also list the parts required for the maintenance check. Work cards can also be configuration specific.

Flow is then to a function block 506 to define the known demands, i.e., the pre-pull parts list. Some work cards require that a certain part to be used, and thus can be identified as a requirement. For example, an oil filter change requires an oil filter canister and a mating o-ring. These parts are added to the recommended bill-of-material as a planned demand since the particular type of oil filter for an aircraft is known and the mating o-ring must be used with that type of oil filter canister for proper operation. These parts are usually identified in a pre-pull parts list.

Flow is then to a function block 508 to define the unknown demands, which are parts which can be identified with some degree of probability based upon maintenance knowledge and experience, to be required or readily available if the maintenance inspection detects that replacement is necessary. In the process of completing the work card, parts may be needed that were not originally requested on the work card, but that based upon operator experience and knowledge, should be made available in the case where the part will need to be replaced upon inspection. These parts will not be required all the time, but can be identified through operator experience. The parts are added to the recommended bill-of-material as unplanned demand, and can be identified within 85% to 90% accuracy.

Flow is then to a function block 510 to match defined demand to current inventory levels. In order to match inventory to the requirements of the maintenance check, both the manufacturer requirements, as well as similar aircraft type experience, will drive the total requirement for the bill-of-materials 440 (FIG. 4).

Flow is then to a function block 512 to match demands, both known and unknown, to the inventory order stream. Situations should be identified where the scheduled order stream does not meet the scheduled demand. It should show on which tail number the deviation will occur and also identify future scheduled deviations.

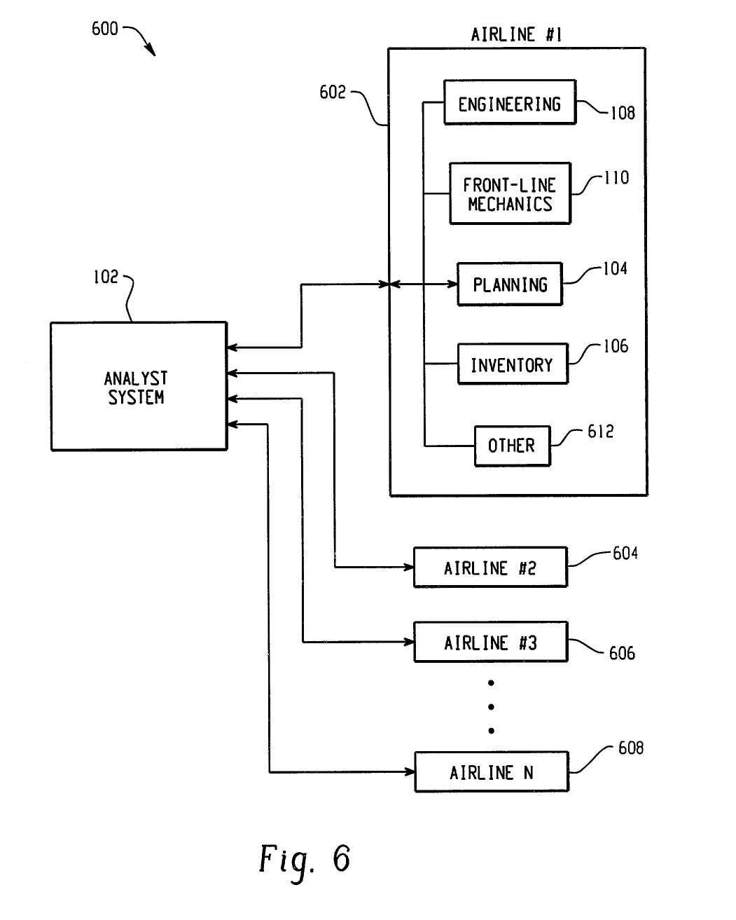

Referring not to FIG. 6, there is illustrated a block diagram 600 connecting multiple airline systems with the analyst system 102 of the present invention. The analyst system 102 is operable to process data from any number of subscriber airlines over wireless or any other type of communication media, e.g., the Internet. Individual airlines feed raw data to the analyst system for processing and output which can provide a total solution for scheduling of maintenance and repair, or to support portions of the airline in-house programming tools for performing such functions. The analyst system processes the received data and can provide individualized information processing. Additionally, a level of service which can be provided integrates information received from various maintenance processes of the separate airlines into a suggested update processes which can be fed back to the airlines based upon knowledge obtained during maintenance and repair processes.

As shown in FIG. 6, airline 1's inputs 602 into the system 102 includes aircraft engineering 108 aircraft mechanic 110, aircraft planning 104, aircraft inventory 106, and other 612 data. Similar data is collected form each of the other airlines such as airline #2 604, airline #3 606 up to and including airline N 608. This enables a larger pool of data to be collected for each type of aircraft and should increase the accuracy of the usage data 436 (FIG. 4) and operator experience 438 (FIG. 4) used in calculating aircraft bill-of materials 440 (FIG. 4).

(Q? Could you please provide some description as to what data is stored in the data field described herein?)

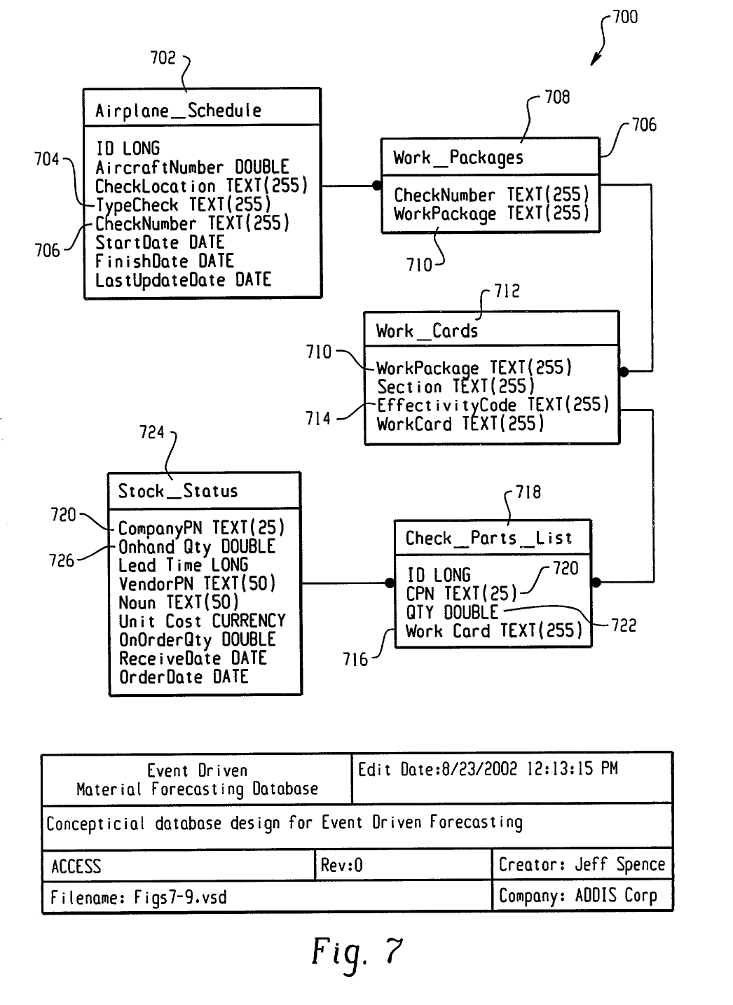

Referring now to FIG. 7 there is shown a block diagram 700 illustrating the relationship between various data files contemplated by the preferred embodiment of the present invention. the Airplane_Schedule file 702 contains data relevant to the schedule of a particular aircraft. Each task is assigned a CheckNumber 706. The TypeCheck field 704 is used to link into the Work_Packages file 708. The Work_Packages file 708 comprises the CheckNumber 704 and the WorkPackage field 710. The WorkPackage field 710 is used to link into the Work_Cards 712 data file. The Work_Cards 712 data file comprises the Work_Package field 710 and the WorkCard field 714. The Workcard field 714 is linked into the Check_Parts_List 718 identifies the quantity of needed parts. The CPN field 720 is used to link to the Stock_Status data 724 and the quantity field 722 is the quantity needed for the task. The Onhand field 726 of the Stock_Status system stores the amount of stock available. The system compares the Qty field 714 of the Check_Parts_List data file 718 to the Onhand Qty 726 field of the Stock_Status 724 data file to determine if materials need to be ordered.

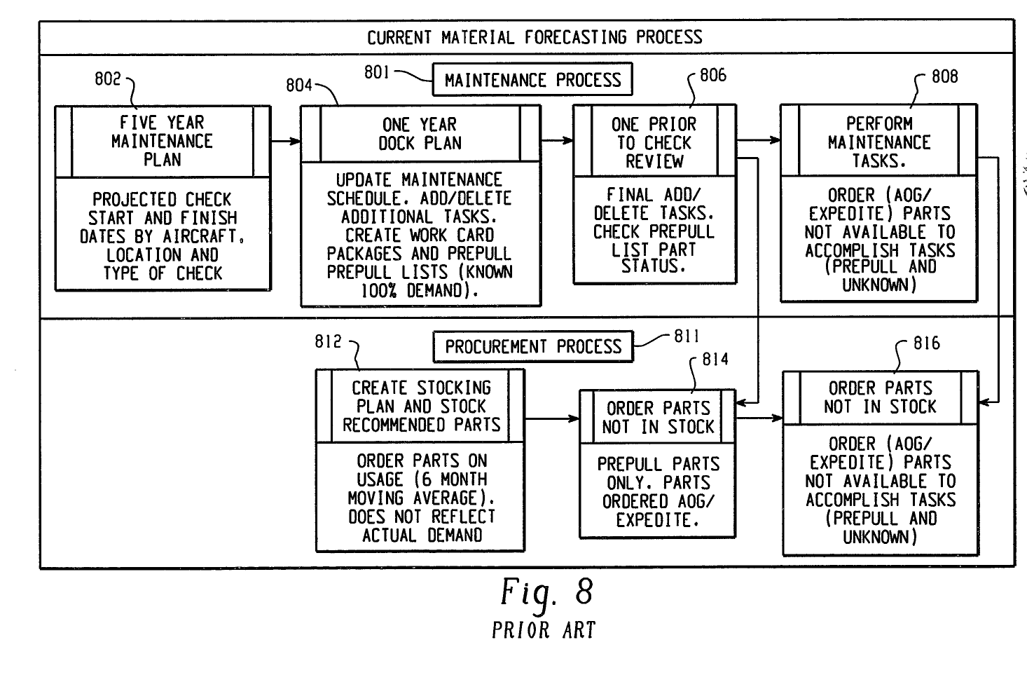

Referring now to FIG. 8 there is shown the typical material forecasting process of the prior art. The upper portion of the drawing refers to the maintenance process 801 while the lower portion of the drawing refers to the procurement process. First, a Five Year Maintenance plan 802 is generated for each aircraft. The plan projects check start and finish dates by aircraft location and type of check. As shown in block 804 a one year dock plan 804 is created. The One Year Dock Plan 804 is used to update maintenance schedules, add, change or delete tasks, create work card packages and create pre-pull lists, which are also known as 100% demand. Then as shown in block 806 there is a final review which adds/delete tasks. At this point pre-pull list part status is checked and is the first link of the maintenance process 801 to the procurement process 811. Typically, as shown in block 812, a stocking plan is created by the procurement process 801. The plan 812 usually orders parts based on a six month moving average of usage and does not reflect actual demand. At step 814 the pre-pull list is checked against stock and at step 814 any parts not in stock are ordered. These ordered parts are for pre-pull items only. As shown in block 808, the tasks is actually preformed, and any parts not on the pre-pull list is ordered to accomplish tasks that were not known. As shown in block 816, the procurement process 811 then orders parts that are not available to complete the scheduled tasks.

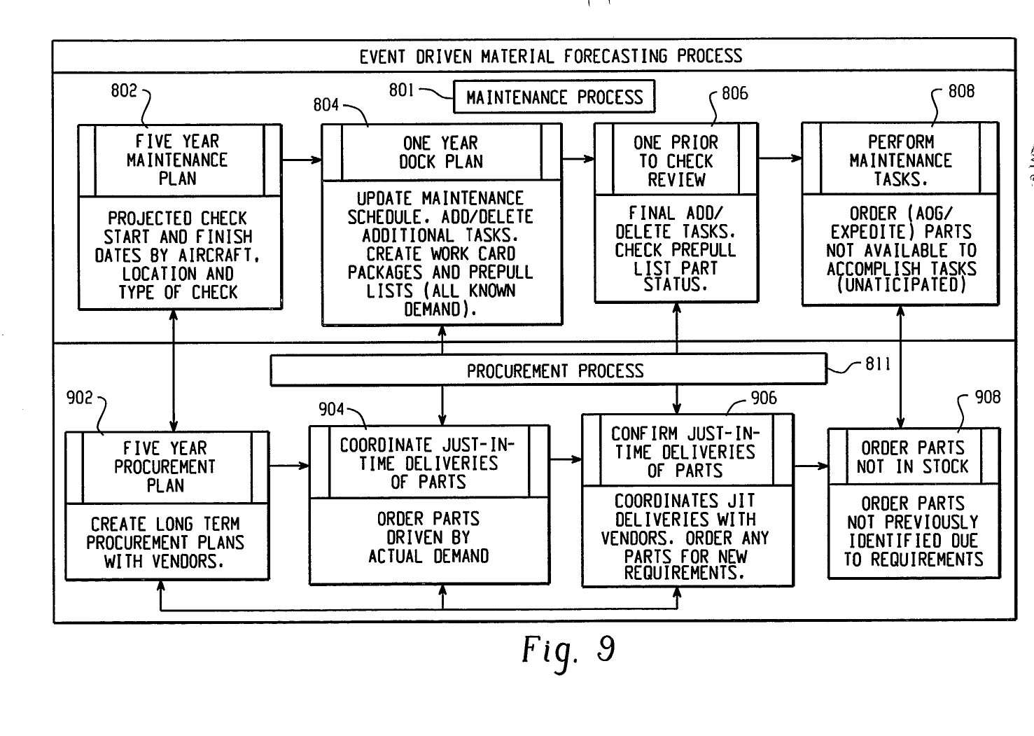

In contrast, FIG. 9 shows an aspect of the event driven material forecasting process as contemplated by the present invention. In FIG. 9 the Maintenance Process 811 comprises blocks 802, 804, 806 and 808, and the Procurement Process comprises blocks 902, 904, 906 and 908. As in the prior art, a five year plan 802, one year plan 804, check review 806 and performance of maintenance 808 are performed. However, the procurement process 811 is more extensively linked with the maintenance process 801. Block 902, the five year procurement plan is linked to block 802 the five year maintenance plan. Thus, when the maintenance plan 802 is developed, the procurement plan 902 is created which creates long term procurement plans with vendors. When the one year dock plan 804 is performed, a link to the procurement process 811 is created to coordinate just-in-time delivery of parts as shown in block 904. It should be noted that the parts are ordered by is driven by actual demand, and not just the long term procurement plan or the moving six month average as shown in block 812 (FIG. 8). At step 806 when the check review is done, there is a link to the procurement process 811 as shown in block 906 where the just-in-time delivery of the parts is confirmed. The delivery of the parts is confirmed and any new parts for any new requirements are ordered. Finally as the task is being performed as shown in step 808, any parts not in stock and not previously identified due to requirements are ordered as shown in step 908.

To summarize, the event driven material forecasting system of the present invention creates a recommended Bill of Materials, which comprises consumables and Line Replacement Units for a given task scheduled at a given time. Material requirements system uses pre-determined scheduling information and by identifying situations wherein the scheduled orders failed to meet actual demand, projects specific requirements to compensate for the situations wherein the scheduled orders failed to meet actual demands.

Specific maintenance requirements are documented and identified, during aircraft Certification, by the regulating agencies and manufacturers. Tasks and required frequencies are specified in the manufacturers recommended maintenance programs. These tasks are required to adequately maintain each airplane. Most airlines will use the manufactures Maintenance-Planning document and customize/modify to meet their requirements. The manufacturing maintenance planning document is the bridge between the regulatory agency requirements and the airline's proof of compliance for the requirements. Using the manufactures maintenance-planning document as a common reference point will allow the sharing of data between airlines.

Each task is then defined. Each maintenance action on an airplane is generated by a task. A Maintenance action is as simple as a preflight check or a more detailed major check, which will consist of many tasks. The larger more detailed check, the more detailed the tasks required. The required tasks can then be broken down into work cards. Work cards define the work to be accomplished and will also list the parts required for the maintenance check. Work cards are can also be configuration specific.

The known demand (Pre-pull parts list) is then defined. Some work cards require a part to be used and can be identified as a requirement. These parts are usually identified in a pre-pull parts list. As an example, an oil filter change requires an oil filter and o-ring. These parts are added to the recommended bill of material as a planned demand.

Unknown demand or unscheduled demand (Maintenance knowledge) is then feedback into the materials forecasting process. In the process of accomplishing the work card, parts may be found, on condition that requires replacement. These parts will not be required all the time, but can be identified through operators' experience. The parts are added to the recommended bill of material as unplanned demand and can be identified within 85% to 90% accurate.

Defined demand is then matched to Inventory levels. In order to match the inventory to the requirement for the maintenance check, both the manufacturers requirement as well as similar aircraft type experience will drive the total requirement for the bill of materials.

Identify situations when and where the scheduled order stream does not meet scheduled demand. It should show on which tail number the deviation will occur and also identify future scheduled deviations. Using this information a bill-of-materials may then be ordered which includes materials for scheduled maintenance tasks and materials which will probably be needed for unscheduled tasks.

Although the invention has been shown and described with respect to a certain preferred embodiment, it is obvious that equivalent alterations and modifications will occur to others skilled in the art upon the reading and understanding of this specification. The present invention includes all such equivalent alterations and modifications and is limited only by the scope of the following claims.

What is claimed is:

1. An event driven material forecasting method, the steps comprising:
defining check requirement, wherein the check requirement comprises a frequency and a pre-determined part;
storing an observed requirement, wherein the observed requirement comprises identifying a replaced part;
projecting an inventory demand based on the pre-determined part and the replaced part; and
determining an order quantity after matching the inventory demand to an inventory level and matching the demand to an inventory order stream.

2. The event driven material forecasting method of claim 1 wherein the storing step further comprises defining a milestone for when the replaced part is needed.

3. The event driven material forecasting method of claim 2 wherein the defining a milestone step further comprises calculating a percentage of occurrences the replacement part is needed at the milestone.

4. The event driven material forecasting method of claim 1 wherein there are a plurality of locations, the projecting step further comprising projecting the inventory demand separately for each location and determining the order quantity separately for each location.

5. The event driven material forecasting method of claim 1 wherein the storing step further comprises defining a frequency based replacement time for the replaced part.

6. The event driven material forecasting method of claim 5 wherein the storing step further comprises calculating a percentage of parts needed for the replacement time.

7. The computer implemented event driven material forecasting method for maintaining aircraft, the steps comprising;
defining check requirement for an aircraft, wherein the check requirement comprises a frequency and a pre-determined part;
storing an observed requirement for the aircraft, wherein the observed requirement comprises identifying a replaced part;
projecting an inventory demand based on the pre-determined part and the replaced part; and
determining an order quantity after matching the inventory demand to an inventory level and matching the demand to an inventory order stream.

8. The computer implemented event driven material forecasting method for maintaining aircraft of claim 7 wherein the storing step further comprises defining a milestone for when the replaced part is needed.

9. The computer implemented event driven material forecasting method for maintaining an aircraft of claim 8 wherein the defining a milestone step further comprises calculating a percentage of occurrences the replacement part is needed at the milestone.

10. The computer implemented event driven material forecasting method for maintaining an aircraft of claim 7 wherein there are a plurality of locations, the projecting step further comprising projecting the inventory demand separately for each location and determining the order quantity separately for each location.

11. The computer implemented event driven material forecasting method for maintaining an aircraft of claim 10 wherein the projecting step further comprises determining a location from the plurality of locations where the aircraft will be located.

12. The computer implemented event driven material forecasting method for maintaining an aircraft of claim 7 wherein the storing step further comprises defining a frequency based replacement time for the replaced part.

13. The computer implemented event driven material forecasting method for maintaining an aircraft of claim 8 wherein the storing step further comprises calculating a percentage of parts needed for the replacement time.

14. A computer-readable medium of instructions comprising:
means for defining check requirements, wherein the check requirements comprises a frequency and a pre-determined part;
means for storing an observed requirement, wherein the observed requirement comprises identifying a replaced part;
means for projecting an inventory demand based on the pre-determined part and the replaced part; and
means for determining an order quantity after matching the inventory demand to an inventory level and matching the demand to an inventory order stream.

15. The computer-readable medium of instructions of claim 14 further comprises means for defining a milestone for when the replaced part is needed.

16. The computer-readable medium of instructions of claim 15 further comprising means for calculating a percentage of occurrences the replacement part is needed at the milestone.

17. The computer-readable medium of instructions of claim 14 further comprising means for projecting the inventory demand separately for each location and determining the order quantity separately for each location of a plurality of locations..

18. The computer-readable medium of instructions of claim 14 further comprising means for defining a frequency based replacement time for the replaced part.

19. The computer-readable medium of instructions of claim 18 further comprising means for calculating a percentage of parts needed for the replacement time.

20. A computer-readable medium of instructions comprising:
means for defining check requirements for an aircraft, wherein the check requirements comprises a frequency and a pre-determined part;
means for storing an observed requirement for the aircraft, wherein the observed requirement comprises identifying a replaced part;
means for projecting an inventory demand based on the pre-determined part and the replaced part; and
means for determining an order quantity after matching the inventory demand to an inventory level and matching the demand to an inventory order stream.

21. The computer-readable medium of instructions of claim 20 further comprising means for defining a milestone for when the replaced part is needed.

22. The computer-readable medium of instructions of claim 21 further comprising means for calculating a percentage of occurrences the replacement part is needed at the milestone.

23. The computer-readable medium of instructions of claim 14 wherein there are a plurality of locations, the computer-readable medium of instructions further comprising means for projecting the inventory demand separately for each location and determining the order quantity separately for each location.

24. The computer-readable medium of instructions of claim 23 further comprising means for determining a location from the plurality of locations where the aircraft will be located.

25. The computer-readable medium of instructions of claim 20 further comprising means for defining a frequency based replacement time for the replaced part.

26. The computer-readable medium of instructions of claim 25 further comprising means for calculating a percentage of parts needed for the replacement time.

27. A system for providing event driven material forecasting comprising:
a computing device having a memory;
a database in the memory including part data, the part data comprising a scheduled demand data, an unscheduled demand data, an inventory level, and an inventory order stream;
an application program, for execution in the computing device and accessing the database, for projecting an inventory demand based on the scheduled demand data and the unscheduled demand data; and
the application program determining an order quantity, after matching the inventory demand to an inventory level and matching the demand to an inventory order stream.

28. The system for providing event driven material forecasting of claim 27, further comprising the application program defining a milestone for when the replaced part is needed.

29. The system for providing event driven material forecasting of claim 28 further comprising the application program calculating a percentage of occurrences the replacement part is needed at the milestone.

30. The system for providing event driven material forecasting of claim 27
wherein the part data further comprises location data for each location of a plurality of locations,
further comprises the application program projecting the inventory demand separately for each location and determining the order quantity separately for each location.

31. The system for providing event driven material forecasting method of claim 27 further comprises the application program defining a frequency based replacement time for the replaced part.

32. The system for providing event driven material forecasting of claim 31 further comprising the application program calculating a percentage of parts needed for the replacement time.

33. The system for providing event driven material forecasting of claim 27 wherein the system is for maintaining aircraft,

34. The for providing event driven material forecasting of claim 27 wherein the computing, the database, and the application program are shared by a plurality of airlines.
